(19) United States
(12) Patent Application Publication
(10) Pub. No.: US 2005/0258377 A1
(43) Pub. Date: Nov. 24, 2005

(54) Radiation image conversion panel

(76) Inventors: Kuniaki Nakano, Kitatsuru-gun (JP); Satoshi Honda, Tokyo (JP); Osamu Morikawa, Tokyo (JP)

Correspondence Address: CANTOR COLBURN LLP, 55 Griffin Road South, Bloomfield, CT, 06002, US

(21) Appl. No.: 10/351,915

(22) Filed: Jan. 27, 2003

(30) Foreign Application Priority Data
Feb. 13, 2002 (JP) P2002-035196

(51) Int. Cl. G03B 42/08

(52) U.S. Cl. 250/484.4

(57) ABSTRACT

A radiation image conversion panel is disclosed, comprising a support having thereon a stimulable phosphor layer comprising a stimulable phosphor having a columnar crystal structure, and the columnar crystal structure having the columnar crystal diameter ratio meeting the following equation (1):
0≦D2/D1≦3.0 (1) A preparation method of the radiation image conversion panel is also disclosed.

### FIELD OF THE INVENTION

The present invention relates to a radiation image conversion panel and a preparation method thereof.

### BACKGROUND OF THE INVENTION

In recent years, radiographic imaging methods have been employed using a radiation image conversion panel employing photo-stimulable phosphors (hereinafter also denoted simply as stimulable phosphors). For example, as disclosed in U.S. Pat. No. 3,859,527 and JP-A No. 55-12144 (hereinafter, the term, JP-A refers to Japanese Patent Application Publication), there is a radiation image conversion panel having a stimulable phosphor layer on the support. The stimulable phosphor layer of the radiation image conversion panel is exposed to radiation rays having passed through respective portions of the object to accumulate radiation energy corresponding to radiation ray transmittance of the respective portion of the object in the stimulable phosphor layer to form latent images (accumulated images) and scanning the stimulable phosphor layer with stimulating light (laser lights are usually used) causes the accumulated radiation ray energy to be radiated to emit light, the intensities of which are read to forming images. The thus formed images may be reproduced on various displays such as CRT or reproduced in the form of a hard copy.

The stimulable phosphor layer of the radiation image conversion panel used in the radiation image conversion method requires enhanced radiation absorption efficiency, enhanced light conversion efficiency, superior image graininess and high sharpness.

To enhance sensitivity to radiation, it is necessary to increase the thickness of the stimulable phosphor layer. However, an excessively thick layer often causes a phenomenon in which stimulated emission light is scattered between phosphor grains, preventing emission from coming out of the layer. With regard to sharpness, a thinner phosphor layer results in enhanced sharpness but an excessively thin layer leads to reduced sensitivity.

Image graininess, in general, depends on local fluctuation in radiation quantum number (so-called quantum mottle) or structural disorder of the stimulable phosphor layer of the radiation image conversion panel (so-call structure mottle). Decreasing the phosphor layer thickness results in a decreased number of radiation quantum to increase the mottle or leads to markedly increased structural disorder to cause the structure mottle to increase, forming deteriorated images. Accordingly, a thinner phosphor layer is needed to enhance image graininess.

As described above, image quality and sensitivity in radiation image conversion methods using the radiation image conversion panel are dependent on various factors. There have been made various studies to achieve improvements in sensitivity and image quality by adjusting plural factors relating to the sensitivity and image quality. Of these, an attempt in controlling the form of stimulable phosphor grains to enhance sensitivity and image quality was made as an means for improving sharpness of radiographic images. For example, JP-A No. 61-142497 discloses a method of using a stimulable phosphor layer comprising a fine columnar block which has been formed by sedimentation of a stimulable phosphor on a support having fine protruded patterns; JP-A 62-39737 discloses a method of using a radiation image conversion panel having a stimulable phosphor layer having a pseudo-columnar form which has been formed by producing cracks on the layer surface side; JP-A 62-110200 proposes a method in which a stimulable phosphor layer having voids is formed by vapor deposition onto the upper surface of a support, followed by growing voids by subjecting a heating treatment to produce cracks.

Recently, JP-A No. 62-157600 disclosed that when forming a stimulable phosphor layer on a support using the vapor-phase deposition method, a phosphor layer is formed to a prescribed thickness, while adjusting the crossing angle between the streamline of stimulable phosphor component vapor and the surface of the support to a specific range. JP-A No. 2899812 proposed a radiation image conversion panel having a stimulable phosphor layer, in which long and thin columnar crystals were formed with an incline at a given angle to the direction normal to the support.

In the foregoing attempts to control the stimulable phosphor layer form, it was intended to enhance image quality by allowing the phosphor layer to have a columnar crystal structure. It was supposed that the columnar form prevented traverse diffusion of stimulated emission light (or photo-stimulated luminescence), i.e., the light reached the support surface with repeating reflection at the interface of cracks (or columnar crystals), thereby leading to markedly enhanced sharpness of images formed by the stimulated luminescence.

However, enhanced image quality is still desired even in radiation image conversion panels having the stimulable phosphor layer which has been formed by the foregoing vapor-phase growth (deposition).

### SUMMARY OF THE INVENTION

It is an object of the present invention to provide a radiation image conversion panel exhibiting enhanced luminescence intensity and superior sharpness, and a preparation method thereof.

The foregoing object of the invention was achieved by the following constitutions 1. through 15:
1. A radiation image conversion panel comprising a support having thereon a stimulable phosphor layer, wherein the stimulable phosphor layer comprises a stimulable phosphor having a columnar crystal structure, and the columnar crystal structure having a columnar crystal diameter ratio satisfying the following equation (1):
   0≦D2/D1<3.0 (1)
   wherein D2 represents a first columnar crystal diameter on the surface of the stimulable phosphor layer and D1 represents a second columnar crystal diameter at a distance of 0/1 T from the surface of the support toward the surface of the stimulable phosphor layer, in which T represents a thickness of the stimulable phosphor layer;
2. The radiation image conversion panel described in 1., wherein the columnar crystal diameter satisfies the following equation (2):
   1.3≦D2/D1≦3.0 (2)
3. The radiation image conversion panel described in 1., wherein the stimulable phosphor layer comprises a stimulable phosphor having the composition represented by the following formula (3):
   M^{I}X·aM^{II}X′₂·bM^{III}X″₃:eA
   wherein M^{I} represents an alkali metal selected from the group consisting of Li, Na, K, Rb and Cs; M^{II} represents a divalent metal selected from the group consisting of Be, Mg, Ca, Sr, Ba, Zn, Cd and Ni; M^{III} represents a trivalent metal selected from the group consisting of Sc, Y, La, Ce, Pr, Nd, Pm, Sm, Eu, Gd, Tb, Dy, Ho, Er, Tm, Yb, Lu, Al, Ga and In; X, X′ and X″ each represent a halogen selected from the group consisting of F, Cl, Br and I; A represents a metal selected from the group consisting of Eu, Tb, In Ga, Cs, Ce, Tm, Dy, Pr, Ho, Nd, Yb, Er, Gd, Lu, Sm, Y, Tl, Na, Ag, Cu and Mg; a, b and e are each 0≦a<0.5, 0≦b<0.5 and 0≦e<0.2;
4. The radiation image conversion panel described in 3., wherein in formula (3), M^{I} is an alkali metal selected from the group consisting of K, Rb and Cs;
5. The radiation image conversion panel described in 3. or 4., wherein in formula (3), X is Br or I;
6. The radiation image conversion panel described in any of 3., 4. and 5., wherein in formula (3), M^{II} represents a divalent metal selected from the group consisting of Be, Mg, Ca, Sr and Ba;
7. The radiation image conversion panel described in any of 3. through 6., wherein in formula (3), M^{III} represents a trivalent metal selected from the group consisting of Y, La, Ce, Sm, Eu, Gd, Lu, Al, Ga and In;
8. The radiation image conversion panel described in any of 3. through 7., wherein in formula (3), 0≦b≦10⁻²;
9. The radiation image conversion panel described in any of 3. through 8., wherein in formula (3), A is a metal selected from the group consisting of Eu, Cs, Sm, Tl and Na;
10. The radiation image conversion panel described in any of 3. through 9., wherein the stimulable phosphor represented by formula (3) is a stimulable phosphor represented by the following formula (4):
   CsX:yA
   wherein X represents Cl, Br or I; A represents Eu, Sm, In, Tl, Ga or Ce; y is a numerical value falling within the range of 1×10⁻⁷ to 1×10⁻²;
11. A method for preparing a radiation image conversion panel described in any of the foregoing 1. through 10., wherein the method comprises a step of forming a stimulable phosphor layer by the vapor-phase deposition process;
12. The method described in 11., wherein the step comprises causing a stimulable phosphor or a raw material thereof to be entered at a prescribed incident angle to the direction normal to the surface of the support to form a stimulable phosphor layer comprising independent columnar crystals having an inclination at a prescribed angle to the direction normal to the surface of the support;
13. The method described in 12., wherein the incident angle is adjusted to the range of 0° to 80°;
14. The method described in 12., wherein the incident angle is adjusted to the range of 0° to 70°;
15. A radiation image conversion panel, which is prepared by the method described in any of the foregoing 11. through 14.

### BRIEF EXPLANATION OF DRAWING

FIGS. 1(a) and 1(b) illustrate a stimulable phosphor layer having a columnar crystal structure.

### DETAILED DESCRIPTION OF THE INVENTION

As a result of extensive study by the inventors of this application, as described in the foregoing 1., there was achieved a radiation image conversion panel comprising on a support a stimulable phosphor layer, wherein the stimulable phosphor layer comprises stimulable phosphor crystals having a columnar crystal structure and the columnar crystal structure satisfies the equation (1) described earlier, thereby leading to a radiation image conversion panel exhibiting enhanced luminescence intensity and superior sharpness.

Stimulable Phosphor Layer

The stimulable phosphor layer relating to the invention will be described.

The stimulable phosphor used in the stimulable phosphor layer is preferably an alkali halide type stimulable phosphor having the composition represented by formula (3) or (4) described earlier, and more preferably one having the composition represented by formula (4). Specifically, a stimulable phosphor having the composition of CsX:Eu (in which X is a halogen, and preferably Cl, Br or I) exhibits enhanced X-ray absorption and achieves enhanced sensitivity. Thus, enhanced sensitivity and enhanced sharpness have been achieved by forming columnar crystals under precise control.

There can be employed material described in JP-B Nos. 7-84589, 7-74334, 7-84591 and 5-01475 (hereiafter, the term JP-B refers to Japanese Patent Publication) to prepare the foregoing stimulable phosphors, such as those represented by formulas (3) and (4).

The stimulable phosphor layer has a columnar crystal structure. Thus, the stimulable phosphor layer comprises a stimulable phosphor comprised of columnar crystals, and the columnar crystals preferably having a crystal structure in which the columnar crystals exist independently (or separately), and individually performing crystal growth with spacing at a specified distance. The method for allowing individual crystals to grow at intervals so as to independently have a columnar crystal structure can be referred to, for example, one described in JP-B No. 2899812. To achieve effects described in the invention, the columnar crystals have a columnar crystal structure meeting the columnar crystal diameter ratio (i.e., D2/D1), as described in the equation (1) and preferably the columnar crystal diameter ratio meeting the equation (2) described earlier.

The stimulable phosphor layer having the columnar crystal structure described above and meeting a specific columnar crystal diameter ratio (D2/D1) is prepared preferably in a vapor-phase deposition process.

Preparation of Stimulable Phosphor Layer by Vapor-phase Deposition Process

A vacuum evaporation method, a sputter deposition method and a CVD method have been employed to allow the stimulable phosphor to perform vapor-phase growth (vapor-phase deposition method) to form columnar crystals.

In such a vapor-phase deposition method, vapor of a stimulable phosphor or raw material thereof is supplied onto a support at a specific angle toward the support to allow crystals to perform vapor-phase growth (vapor-phase deposition) to form a stimulable phosphor layer having long, thin columnar crystal structures which exist independently. Thus, a stimulable phosphor or a raw material thereof is caused to be entered at a prescribed incident angle to the direction normal to the surface of the support to form a stimulable phosphor layer comprising independent columnar crystals. Upon vacuum evaporation, the columnar crystals can be grown at a growing angle which is about half of the incident angle of the vapor stream of the stimulable phosphor.

To supply the vapor stream of a stimulable phosphor or raw material thereof at an incident angle to the support, the support and a crucible containing an evaporation source may be arranged so as to be inclined with each other. Alternatively, the support and the crucible which are arranged parallel to each other may be controlled so that only an inclined component from the evaporating surface of the crucible having an evaporation source deposits on the support using a slit. In such as case, the shortest spacing between the support and the crucible is preferably 10 to 60 cm so as to fit the average flight of the stimulable phosphor.

The thickness of the columnar crystal, i.e., the columnar crystal diameter is affected by the temperature of the support, the degree of vacuum and the incident angle of the vapor stream, so that columnar crystals of a desired thickness can be prepared by controlling these factors. The lower temperature of the support tends to render the crystals thinner but excessively low temperature makes it difficult to maintain the columnar form. The temperature of a support is preferably 100 to 300° C., and more preferably 150 to 270° C. In cases where the incident angle of the vapor stream is greater than 0°, the columnar crystals become thinner at the greater angle, in which the preferred incident angle is 30 to 80°, and more preferably 30 to 70°. Further, in cases of the incident angle being greater than 0°, the higher vacuum forms thinner columnar crystals, in which the preferred degree of vacuum is not more than 0.0013 Pa. In cases of the incident angle being 0°, the lower degree of vacuum in the low vacuum region forms thinner columnar crystals, in which the preferred degree of vacuum is not more than 0.13 Pa. Furthermore, the columnar crystal diameter ratio (D2/D1) can optimally be controlled by optimally varying the temperature of the support, the degree of vacuum and the incident angle of the vapor stream.

In order to enhance a modulation transfer function (MTF) of the stimulable phosphor comprised of columnar crystals, the columnar crystal diameter is preferably 1 to 50 μm, and more preferably 1 to 30 μm. The columnar crystal diameter refers to an average value of diameters of circles equivalent to areas of the section (or so-called circular equivalent diameter of the section) of the columnar crystals when viewed from the side parallel to the support surface. In the invention, the columnar crystal diameter is determined by measuring at least 100 columnar crystals in electron micrographs. Thus, the foregoing columnar crystal diameters D1 and D2 are each an average value of columnar crystal diameters, as defined earlier, which can be determined by electron-microscopic observation of at least 100 columnar crystals. Columnar crystals thinner than 1 μm result in lowered MTF due to scattering of stimulated luminescence by the columnar crystals; on the contrary, columnar crystals thicker than So μm result in lowered directionality of stimulated luminescence, and also lowering the MTF.

The spacing between respective columnar crystals is preferably not more than 30 μm, and more preferably not more than 5 μm. Spacing exceeding 30 μm lowers the filling ratio of a phosphor of the phosphor layer. The growth angle of inclined columnar crystals of the stimulable phosphor described earlier is more than 0° and not more than 90°, preferably 10 to 70°, and more preferably 20 to 55°. A growth angle of 10 to 70° can be achieved by an incident angle of 20 to 80°, and a growth angle of 20 to 55° can be achieved by an incident angle of 40 to 70°. A greater growth angle results in a columnar crystal excessively inclined toward the support, forming a brittle layer.

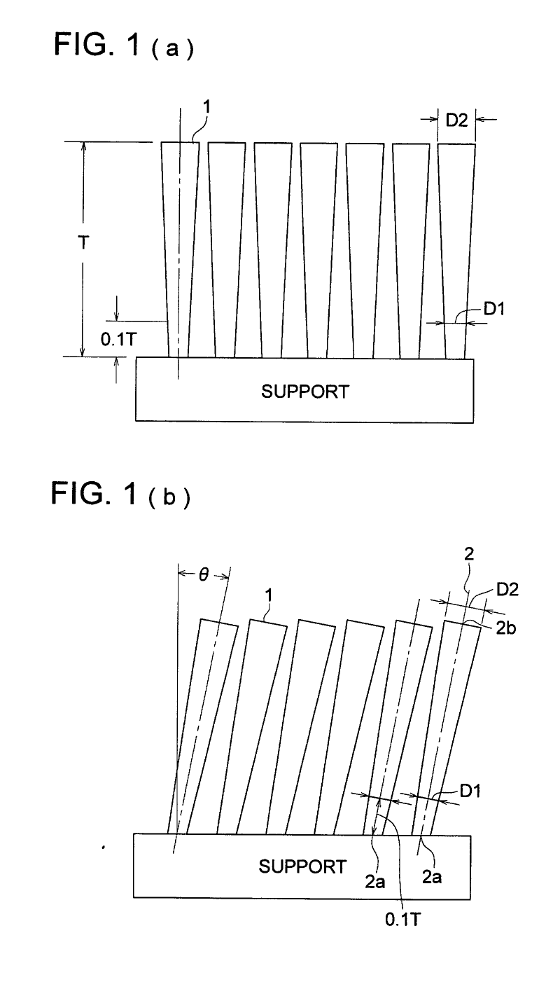

The columnar crystals relating to the invention will be further described based on FIGS. 1(a) and 1(b). FIGS. 1(a) and 1(b) illustrate a stimulable phosphor layer having a columnar crystal structure. Specifically, FIG. 1(a) illustrates a columnar crystal (1) which is formed in an up-right position on the support, in which “T” represents the length of the columnar crystal and “0.1 T” represents the position which is apart from the support at a distance of 1/10 of the length (T) of the columnar crystal (1). D2 represents the diameter (or thickness) of the columnar crystal (1) at the uppermost surface of the columnar crystal, i.e., at a distance of T apart from the support; and D1 represents the diameter (or thickness) of the columnar crystal at the position which exists at a distance of 0.1 T apart from the support. In cases when the columnar crystals uprightly grow, the incident angle of a vapor stream of a stimulable phosphor or raw material thereof is 0° to the support surface.

FIG. 1(b) illustrates crystal growth differing from that of FIG. 1(a), in which the columnar crystal (1) grows at a slant to the support, while having a growth angle of θ. In FIG. 1(b), when straight line (2) is drawn connecting midpoint (2a) on the columnar crystal face in contact with the support and midpoint (2b) on the uppermost surface of the columnar crystal (1), a diameter (or a thickness, which is represented in terms of circular equivalent diameter) of the section intersecting at right angles to the straight line (2) with the position on the straight line (2), which is apart from the support by a distance of 0.1 T is defined as D1. Similarly, a diameter (or a thickness) of the section intercrossing at right angles to the straight line (2) with a midpoint (2b) on the uppermost surface of the columnar crystal (1) is defined as D2.

In FIG. 1(b), for example, when the incident angle of a vapor stream of raw material of a stimulable phosphor is set at 400, the growth angle (θ) of the columnar crystal (1) is half of the incident angle, that is, 20°.

Vacuum Evaporation Method

Vacuum evaporation is conducted in such a manner that after placing a support in an evaporation apparatus, the inside of the apparatus is evacuated to a vacuum degree of 1.333×10⁻⁴ Pa and subsequently, at least a stimulable phosphor is evaporated with heating by the resistance heating method or electron-beam method to cause the phosphor to deposit at a slant on the surface of the support to a desired thickness. As a result, a stimulable phosphor layer containing no binder is formed, provided that the foregoing evaporation stage may be divided into plural times to form the stimulable phosphor layer. In this evaporation stage, plural resistance heaters or electron beams may be used to perform vacuum evaporation. Alternatively, raw material of a stimulable phosphor is evaporated using plural resistance heaters or electron beams and an intended stimulable phosphor is synthesized on the support, simultaneously forming a stimulable phosphor layer. Vacuum evaporation may be conducted while cooling or heating the substrate to be deposited thereon. After completion of vacuum evaporation, the stimulable phosphor layer may be subjected to a heating treatment.

Sputter Deposition Method

Sputter deposition is conducted in such a manner that after setting a support in a sputtering apparatus, the inside of the apparatus is evacuated to a vacuum level of 1.333×10⁻⁴ Pa and then inert gas used for sputtering such as Ar and Ne is introduced thereto at a gas pressure of ca. 1.333×10⁻⁴ Pa, subsequently, sputtering is carried out in the inclined direction with tagetting the stimulable phosphor to cause the phosphor to deposit at a slant on the surface of the support so as to have a desired thickness. Similarly to the vacuum evaporation, the sputtering stage may be divided to plural steps to form a stimulable phosphor layer. Sputtering to the target may be carried out concurrently or successively to form a stimulable phosphor layer. Using plural raw materials of a stimulable phosphor as a target, sputtering is simultaneously or successively carried out to form an intended stimulable phosphor layer on the support. Gas such as O₂ and H₂ may optionally introduced to perform reactive sputtering. Sputtering may be carried out while heating or cooling substrate to be deposited thereon. After completion of sputtering, the stimulable phosphor layer may be subjected to a heating treatment.

CVD Method

CVD (Chemical Vapor Deposition) is a method in which an intended stimulable phosphor or an organic compound containing a raw material of the stimulable phosphor is degraded using energy such as heat or high-frequency electric power to form a stimulable phosphor layer containing no binder on the support, which enables growing respectively long thin columnar crystals inclined at an out-of-plumbness, i.e., at a specific angle to the line normal to the surface of the support.

Stimulable Phosphor Layer Thickness

The thickness of the thus formed stimulable phosphor layer, depending on radiation sensitivity to radiation of an intended radiation image conversion panel and the kind of stimulable phosphor, is preferably 10 to 1000 μm, and more preferably 20 to 800 μm.

In the formation of a stimulable phosphor layer by the vapor-phase deposition methods described above, a stimulable phosphor as an evaporation source may be melted homogeneously or molded by a press or hot-press, followed by being charged into a crucible. Further, it is preferred to conduct a degassing treatment. Evaporation of a stimulable phosphor from the evaporation source can be conducted by scanning with electron beams ejected from an electron gun but other methods may be applied to perform the evaporation. The evaporation source is not necessarily a stimulable phosphor and raw material of a stimulable phosphor may be mixed thereto.

With respect to activators, a mixture of an activator with basic substance may be evaporated. Alternatively, the basic substance is evaporated, followed by doping the activator. For example, RbBr, as basic substance is evaporated alone, followed by doping Tl as an activator. In this case, since respective crystals exist isolatedly, doping becomes feasible even in the case of a thick phosphor layer and difficulty in proceeding crystal growth results in no reduced MTF.

Doping is performed by allowing a doping agent (dopant) to be introduced into the basic substance layer of a phosphor by means of thermal diffusion or ion injection.

The stimulable phosphor layer formed on the support contains no binder, leading to superior directionality and enhanced directionality of stimulating light and stimulated luminescence and enabling formation of a thicker phosphor layer, as compared to radiation image conversion panel having a dispersion-type stimulable phosphor layer, in which a stimulable phosphor is dispersed in a binder. Moreover, reduced scattering of stimulating light in the stimulable phosphor layer results in enhanced sharpness.

Further, spacing between columnar crystals may be filled with a filler such as a binder to strengthen the phosphor layer. Furthermore, material exhibiting relatively high light absorbance or high reflectance may be used as filler. The use thereof prevents lateral diffusion of stimulating light entering into the phosphor layer, in addition to the foregoing strengthening effect. The material exhibiting high reflectance refers to one exhibiting a high reflectance with respect to stimulating light (500 to 900 nm, specifically 600 to 800 nm), including metals such as aluminum, magnesium, silver and indium, white pigments and colorants ranging green to red.

White pigments can also reflect stimulating light. Examples thereof include TiO₂ (anatase type, rutile type), Mgo, PbCO₃, Pb(OH)₂, BaSO₄, Al₂O₃, M(II)FX [in which M(II) is at least one of Ba, Sr and Ca, X is at least one of Cl and Br], CaCO₃, ZnO, Sb₂O₃, SiO₂, ZrO₂, lithopone (BaSO₄—ZnS), magnesium silicate, basic lead silisulfate, and aluminum silicate. These pigments exhibit high covering power and have a refractive index high, whereby stimulated luminescence is easily scattered through reflection or refraction, leading to enhanced sensitivity of the radiation image conversion panel.

Examples of material exhibiting high light absorbance include carbon, chromium oxide, nickel oxide, iron oxide, and blue colorants. Of these, carbon absorbs stimulated luminescence.

Colorants may be any organic or inorganic colorants. Examples of organic colorants include Zapon Fastblue 3G (produced by Hoechst A.G.), Estrol Brillblue N-3RL (produced by Sumitomo Chemical Ind. Co.Ltd.), D6CBlue No. 1 (produced by National Aniline Co.), Spirit Blue (produced by HODOGAYA KAGAKU Co., Ltd.), Oilblue No. 603 (produced by Orient Co., Ltd.), Kiton Blue A (produced by Chiba Geigy Co.), Aisen Catironblue GLH (produced by HODOGAYA KAGAKU Co., Ltd.), Lakeblue AFH (produced by KYOWA SANGYO Co., Ltd.), Primocyanine 6GX (produced by INAHATA SANGYO o. Ltd.), Briilacid Green 6BH (produced by HODOGAYA KAGAKU Co., Ltd.), Cyanblue BNRCS (produced by Toyo Ink Co., Ltd.), and Lyonoyl Blue SL (produced by Toyo Ink Co., Ltd.). There are also cited organic metal complex colorants such as Color Index 24411, 23160, 74180, 74200, 22800, 23154, 23155, 24401, 14830, 15050, 15760, 15707, 17941, 74220, 13425, 13361, 13420, 11836, 74140, 74380, 74350 and 74460. Examples of inorganic colorants include ultramarine, cobalt blue, celureun blue, chromium oxide, and TiO₂—ZnO—NiO type pigments.

Examples of stimulable phosphors used the radiation image conversion panel of the invention include a phosphor represented by BaSO₄:Ax, as described in JP-A No. 48-80487; phosphor represented by MgSO₄:Ax, as described in JP-A No. 48-80488; phosphor represented by SrSO₄:Ax, as described in JP-A No. 48-80489; phosphors Na₂SO₄, CaSO₄ or BaSO₄ added with at least one of Mn, Dy and Tb, as described in JP-A No. 51-29889; phosphors BeO, LiF, MgSO₄ and CaF₂, as described in JP-A No. 52-30487; phosphor Li₂B₄O₇:Cu, Ag, as described in JP-A No. 54-47883; and SrS:Ce, Sm, SrS:Eu, Sm, La₂O₂S:Eu, Sm and (Zn, Cd)S:Mnₓ, as described in U.S. Pat. No. 3,859,527.

There are also cited ZnS:Cu, Pb phosphor and alkaline earth metal silicate type phosphors represented by general formula, BaO.xAl₂O₃:Eu, as described in JP-A No. 55-12142.

There are further cited an alkaline earth fluorohalide phosphor represented by general formula of (Ba_{1-x-y}MgₓCa_{y})Fₓ:Eu²⁺, as described in JP-A No. 55-12143; phosphor represented by general formula: LnOX:xA, as described in JP-A No. 55-12144; phosphor represented by general formula of (Ba₁₋ₓM(II)ₓ)Fₓ:yA, as described in JP-A No. 55-12145; phosphor represented by general formula of BaFX:xCe,yA, as described in JP-A No. 55-84389; rare earth-activated divalent metal fluorohalide phosphor represented by general formula of M(II)FX.xA:yLn, as described in JP-A No. 55-160078; phosphor represented by general formula of ZnS:A,CdS:A, (Zn,Cd)S:A, X; phosphor represented by general formulas of XM₃(PO₄)₂.NX₂:yA and xM₃(PO₄)₂:yA, as described in JP-A No. 59-38278; phosphor represented by general formulas of nReX₃.mAX′₂:xEu and nReX₃.mAX′₂:xEu, ySm, as described in JP-A No. 59-155487; alkali halide phosphor represented by general formula of M(I)X.aM(II)X′₂.bM(III)X″₃:cA, as described in JP-A No.61-72087; and bismuth-activated alkali halide phosphor represented by general formula of M(I)X:xBi, as described in JP-A No. 61-228400.

Specifically, alkali halide phosphors easily, which form a columnar stimulable phosphor layer by the vacuum evaporation method or the sputter method are preferred. Of alkali halide phosphors, CsBr type phosphors are preferred in terms of enhanced luminance and superior image quality.

Support

Next, supports used in the invention will be described. There are used, as a support, a variety of polymeric materials, glass, ceramics and metals. Preferred examples thereof include plate glass such as quartz, borosilicate glass, chemically tempered glass and crystallized glass; ceramics such as alumina and silicon nitride; plastic film such as cellulose acetate film, polyester film, polyethylene terephthalate film, polyamide film, polyimide film, triacetate film, and polycarbonate film; metal sheets such as aluminum, iron, copper and chromium, and metal sheet covered with a hydrophilic fine particle layer. The support may be smooth-surfaced, or it may be matted in order to enhance adhesion of the support to the stimulable phosphor layer. To enhance adhesion between the support and stimulable phosphor layer, the surface of the support may optionally be provided with an adhesion promoting layer in advance.

A thickness of the support, depending on material, is usually 80 to 2000 μm, and preferably 80 to 1000 μm in terms of handling.

### EXAMPLES

The present invention will be further described based examples but embodiments of the invention are not limited to these.

### Example 1

### Preparation of Radiation Image Conversion Panel 1

### Comparative Example

Preparation of Support 1

On 500 mμ thick transparent crystallized glass was provided the following light reflection layer to prepare support 1.

Formation of Light Reflection Layer

Titanium oxide (produced by FURUUCHI KAGAKU Co., Ltd) and zirconium oxide (produced by FURUUCHI KAGAKU Co., Ltd) were evaporated using a vapor deposition apparatus to form a layer on the surface of the support so as to exhibit a reflectance of 85% at 400 nm and a reflectance of 20% at 660 nm.

Preparation of Stimulable Phosphor Plate 1

The thus prepared support 1 was heated at 240° C. and put into a vacuum chamber. After introducing nitrogen gas, the chamber was evacuated to a degree of vacuum of 0.27 Pa. Using a commonly known vapor deposition apparatus, an alkali halide phosphor of CsBr:O.OOlEu was allowed to deposit on one side of the support at an incident angle of 0° to the direction normal to the surface of the support and at a distance of 60 cm between the support and an aluminum slit (evaporation source), while transporting the support in the direction parallel to the surface of the support. There was thus formed a 300 μm thick phosphor layer having a columnar crystal structure.

The phosphor layer exhibited a haze coefficient of 50%, which was determined in accordance with the method of ASTM-1003.

Using the thus prepared stimulable phosphor plate 1, radiation image conversion panel 1 was prepared. Thus, a spacer was provided on the circumferential portion of the glass support having the stimulable phosphor layer and further thereon a protective glass plate as a protective layer was provided so as to have a space of 100 μm (air layer) as a low refractive layer. The spacer, which was made of ceramic glass was allowed to intervene between the support and the protective glass plate and adjusted so that the phosphor layer and the low refractive layer (air layer) had respectively a given thickness. The spacer was adhered to the circumferential portions of the glass support and the protective glass using an epoxy adhesive. Radiation conversion panel 1 was thus obtained.

### Preparation of Radiation Image conversion Panel 2 and 3

### Comparative Example

Radiation image conversion panels 2 and 3 were prepared similarly to radiation image conversion panel 1, provided that the evaporation condition was changed as shown in Table Preparation of Radiation Image conversion Panel 4 to 9

### Inventive Example

Radiation image conversion panels 4 through 9 were prepared similarly to radiation image conversion panel 1, provided that the evaporation condition was changed as shown in Table 1.

In the evaporation condition shown in Table 1, support temperature, degree of vacuum and incident angle were changed at the time when a length of the columnar crystal formed on the support reached about 50% (±5%) of the prescribed length of the columnar crystal, T, as shown in FIG. 1(a) and 1(b). As shown in Table 1, for example, in the preparation process of panel No. 4, the support temperature was changed from 200° C. to 160 and in the preparation process I of panel No. 5, the degree of vacuum was changed from 0.27 to 0.81 Pa. The change time (or timing) was determined based on experimental data which were obtained by observing the crystal growth speed using an electron microscope. The columnar crystal diameter (D1, D2) was determined by electron-microscopic observation of at least 100 columnar crystals.

Radiation image conversion panels 1 through 9 were each evaluated with respect to stimulated emission luminance and sharpness, as described below.

Sharpness

Modulation transfer function (MTF) was determined to evaluate sharpness. Thus, after a CTF chart was adhered to the respective radiation image conversion panels, each of the panels were exposed to X-ray of 10 mR (at a distance to the object: 1.5 m). Thereafter, the phosphor layer side of the panel was irradiated with semiconductor laser light (690 nm, a power of 40 mW on the panel) and the CTF chart was scanned with a semiconductor laser light beam of 100 μm diameter to read it. As shown in Table 1, MTF values (sharpness) of the respective panels were represented by a relative value, based on the MTF value at 0.51 p/mm of panel 1 being 1.00.

Luminance (Sensitivity)

Radiation image conversion panels 1 through 9 were measured with respect to luminance, according to the following manner. The radiation image conversion panels were each exposed to X-rays at a bulb voltage of 80 kVp from the backside of the panel, followed by stimulating the exposed panel with He—Ne laser (633 nm) and stimulated luminescence emitted from the phosphor layer was received by a receptor (photomultiplier having spectral sensitivity of S-5) to determine the intensity thereof. The thus obtained intensity was defined as luminance, which was represented by a relative value, based on that of radiation image conversion panel 4 being 1.00.

The thus obtained results were shown in Table 1.

TABLE 1

| | | | | | | Evaporation Condition | | | |
|---|---|---|---|---|---|---|---|---|---|
| | Column | | | | | | Support | | |
| | Diameter | | Aspect | | | | Tempera- | Vacuum | |
| Panel | (μm) | | Ratio | Lumin- | Sharp- | Incident | ture | Degree | Re- |
| No. | D1 | D2 | (D2/D1) | ance | ness | Angle | (° C.) | (Pa) | mark |
| 1 | 5 | 18 | 3.6 | 0.90 | 0.76 | 0° | 240 | 0.27 | Comp. |
| 2 | 3 | 12 | 4.0 | 0.85 | 0.81 | 0° | 200 | 0.013 | Comp. |
| 3 | 2 | 8 | 4.0 | 0.81 | 0.86 | 40° | 200 | 0.00067 | Comp. |
| 4 | 3 | 7 | 2.3 | 0.93 | 1.00 | 0° | 200→160 | 0.27 | Inv. |
| 5 | 5 | 8 | 1.6 | 0.96 | 0.97 | 0° | 200 | 0.27→0.81 | Inv. |
| 6 | 8 | 9 | 1.1 | 1.00 | 0.91 | 0° | 260→220 | 0.27→0.81 | Inv. |
| 7 | 8 | 13 | 1.6 | 0.98 | 0.89 | 0° | 260→220 | 0.27 | Inv. |
| 8 | 3 | 6 | 2.0 | 0.94 | 1.00 | 40° | 240→200 | 0.00067 | Inv. |
| 9 | 6 | 7 | 1.2 | 0.98 | 0.94 | 40°→60° | 200 | 0.00067 | Inv. |

As can be seen from Table 1, it was proved that radiation image conversion panel samples of the invention exhibited enhanced stimulated luminescence and superior sharpness, as compared to comparative samples.

1. A radiation image conversion panel comprising a support having thereon a stimulable phosphor layer, wherein the stimulable phosphor layer comprises stimulable phosphor crystals having a columnar crystal structure, and said columnar crystal structure having a columnar crystal diameter ratio meeting the following equation (2):
1.3≦D2/D1≦3.0 (2)
wherein D2 represents a first columnar crystal diameter on the surface of the stimulable phosphor layer and D1 represents a second columnar crystal diameter at a distance of 0.1 T from the surface of the support toward the surface of the stimulable phosphor layer, in which T represents a thickness of the stimulable phosphor layer stimulable phosphor is represented by the following formula (4):
CsX:yA formula (4)
wherein X represents Cl, Br or I: A respresents Eu, Sm, In, Tl, Ga or Ce: y is a numerical value falling within the range of 1×10⁻⁷ to 1×10⁻².

2-10. (canceled)

11. The radiation image conversion panel of claim 1, wherein the stimulable phosphor layer is formed by a vapor deposition process.

12. The radiation image conversion panel of claim 11, wherein the process comprises causing a stimulable phosphar or a raw material thereof to be entered at a prescribed incident angle to the direction normal to the surface of the support.

13. The radiation image conversion panel of claim 12, wherein the incident angle is within the range of 0° to 80°.
